(19) United States
(12) Patent Application Publication
(10) Pub. No.: US 2026/0063928 A1
(43) Pub. Date: Mar. 5, 2026

(54) METHOD AND APPARATUS FOR OPTICAL FREQUENCY COMB LOCKING

(71) Applicants: JINAN INSTITUTE OF QUANTUM TECHNOLOGY, Jinan (CN); HEFEI NATIONAL LABORATORY, Hefei (CN)

(72) Inventors: Faxi CHEN, Jinan (CN); Kan ZHAO, Hefei (CN); Libo LI, Hefei (CN); Xianbin SHAO, Hefei (CN); Yubo XIN, Hefei (CN); Pingan MA, Hefei (CN); Jia SUN, Hefei (CN); Chuanxiang WU, Hefei (CN); Haifeng JIANG, Hefei (CN)

(73) Assignees: JINAN INSTITUTE OF QUANTUM TECHNOLOGY, Jinan (CN); HEFEI NATIONAL LABORATORY, Hefei (CN)

(21) Appl. No.: 19/255,973

(22) Filed: Jun. 30, 2025

(30) Foreign Application Priority Data
Sep. 5, 2024 (CN) 202411238399.7

(51) Int. Cl. G02F 1/01

(52) U.S. Cl. CPC G02F 1/0121; G02F 2203/56

(57) ABSTRACT

A method and an apparatus for optical frequency comb locking are provided, relating to the field of frequency control of optical frequency combs. A first electrical signal and second electrical signal outputted by an optical frequency comb system are acquired. Target carrier-envelope offset (CEO) frequency control data and target repetition rate control data are generated based on the first electrical signal, second electrical signal, a CEO frequency radio frequency (RF) reference signal and repetition rate RF reference signal. A first and a second decoupling module synchronously perform decoupling on the data to obtain a first control quantity and second control quantity. The first digital-to-analog converter converts the first control quantity into a first control signal, and simultaneously the second digital-to-analog converter converts the second control quantity into a second control signal. The first and second control signals are inputted to the optical frequency comb system after amplified.

### CROSS-REFERENCE TO RELATED APPLICATIONS

The present application claims priority to Chinese Patent Application No. 202411238399.7, titled “METHOD AND APPARATUS FOR OPTICAL FREQUENCY COMB LOCKING”, filed on Sep. 5, 2024 with the China National Intellectual Property Administration, which is incorporated herein by reference in its entirety.

### FIELD

The present disclosure relates to the field of frequency control of optical frequency combs, and in particular to a method and an apparatus for optical frequency comb locking.

### BACKGROUND

An optical frequency comb, currently a most effective tool for optical frequency measurement and conversion, provides a foundation for developing high-resolution, high-precision, and high-accuracy frequency standards and offers an ideal research tool for scientific fields such as precision spectroscopy, astrophysics, and quantum manipulation. Optical frequency combs have a wide range of applications in fields such as precision optical frequency measurement, measurement of atomic and ionic transition energy levels, remote signal clock synchronization, and satellite navigation. A carrier-envelope offset (CEO) frequency f_{ceo} and a repetition rate fᵣ of the optical frequency comb are two degrees of freedom that are precisely controlled by locking, and are a basis for effective application of the optical frequency comb.

In conventional optical frequency comb systems, f_{ceo} and fᵣ are typically independently controlled by locking. However, due to inherent features of the optical system, fᵣ is inevitably affected during a control process for f_{ceo}, and similarly, f_{ceo} is inevitably affected during a control process for fᵣ. This substantial coupling between the two locked loops compromises independence of their respective locking processes, impedes enhancement of a locking bandwidth and reduction of phase noise of the optical frequency comb, and may even induce system self-oscillation, making the system inoperable. In conventional methods, the impact of coupling is reduced by staggering locking bandwidths of the two loops, that is, reducing the bandwidth of one loop to maintain system stability. However, this method fails to fundamentally address the adverse impact of coupling between the two locked loops on critical parameters like locking bandwidth and phase noise in optical frequency comb systems.

### SUMMARY

In view of this, a method and an apparatus for optical frequency comb locking are provided in the present disclosure, to effectively reduce coupling between two locked loops (carrier-envelope offset (CEO) frequency and repetition rate), reduce phase noise and ensure that the two locked loops have the same bandwidth, to improve a locking bandwidth.

In a first aspect, a method for optical frequency comb locking is provided according to the present disclosure. The method includes:
acquiring a first electrical signal outputted by a CEO frequency detection module and a second electrical signal outputted by a repetition rate detection module in an optical frequency comb system;
generating a target CEO frequency error signal based on the first electrical signal and a CEO frequency radio frequency (RF) reference signal, and calculating target CEO frequency control data through performing a proportional-integral operation on the target CEO frequency error signal;
generating a target repetition rate error signal based on the second electrical signal and a repetition rate RF reference signal, and calculating target repetition rate control data through performing the proportional-integral operation on the target repetition rate error signal;
inputting the target CEO frequency control data and the target repetition rate control data to a first decoupling module to output a first control quantity, wherein the first decoupling module performs calculation on the target CEO frequency control data and the target repetition rate control data by using coupling coefficients in a coupling coefficient set to obtain the first control quantity, wherein the coupling coefficient set includes a first coupling coefficient, a second coupling coefficient, a third coupling coefficient and a fourth coupling coefficient;
inputting the target CEO frequency control data and the target repetition rate control data to a second decoupling module to output a second control quantity, wherein the second decoupling module performs calculation on the target CEO frequency control data and the target repetition rate control data by using the coupling coefficients in the coupling coefficient set to obtain the second control quantity;
converting the first control quantity into a first control signal by a first digital-to-analog converter and simultaneously, converting the second control quantity into a second control signal by a second digital-to-analog converter;
amplifying the first control signal via a first amplifier, and inputting the amplified first control signal to a CEO frequency control module in the optical frequency comb system; and
amplifying the second control signal via a second amplifier, and inputting the amplified second control signal to a repetition rate control module in the optical frequency comb system.

In an embodiment, the generating a target CEO frequency error signal based on the first electrical signal and a CEO frequency radio frequency (RF) reference signal includes:
inputting the first electrical signal and the CEO frequency RF reference signal to a first digital mixer to output a first mixing result; and
inputting the first mixing result to a first digital low-pass filter to obtain the target CEO frequency error signal.

In an embodiment, the generating a target repetition rate error signal based on the second electrical signal and a repetition rate RF reference signal includes:
inputting the second electrical signal and the repetition rate RF reference signal to a second digital mixer to output a second mixing result; and
inputting the second mixing result to a second digital low-pass filter to obtain the target repetition rate error signal.

In an embodiment, generating the coupling coefficient set includes:
adjusting an output of the first digital-to-analog converter after the optical frequency comb system is powered on and operates stably over a target duration, and measuring a first variation of a CEO frequency and a first variation of a repetition rate;
determining the first coupling coefficient based on the first variation of the CEO frequency;
determining the second coupling coefficient based on the first variation of the repetition rate;
adjusting an output of the second digital-to-analog converter after the optical frequency comb system is powered on and operates stably over the target duration, and measuring a second variation of the CEO frequency and a second variation of the repetition rate;
determining the third coupling coefficient based on the second variation of the CEO frequency; and
determining the fourth coupling coefficient based on the second variation of the repetition rate.

In a second aspect, an apparatus for optical frequency comb locking is provided according to the present disclosure. The apparatus includes an acquisition unit, a first generation unit, a second generation unit, a first control quantity determination unit and a second control quantity determination unit.

The acquisition unit is configured to acquire a first electrical signal outputted by a carrier-envelope offset (CEO) frequency detection module and a second electrical signal outputted by a repetition rate detection module in an optical frequency comb system.

The first generation unit is configured to generate a target CEO frequency error signal based on the first electrical signal and a CEO frequency radio frequency (RF) reference signal, wherein a proportional-integral operation is performed on the target CEO frequency error signal to obtain target CEO frequency control data.

The second generation unit is configured to generate a target repetition rate error signal based on the second electrical signal and a repetition rate RF reference signal, wherein the proportional-integral operation is performed on the target repetition rate error signal to obtain target repetition rate control data.

The first control quantity determination unit is configured to input the target CEO frequency control data and the target repetition rate control data to a first decoupling module to output a first control quantity, wherein the first decoupling module performs calculation on the target CEO frequency control data and the target repetition rate control data by using coupling coefficients in a coupling coefficient set to obtain the first control quantity, wherein the coupling coefficient set includes a first coupling coefficient, a second coupling coefficient, a third coupling coefficient and a fourth coupling coefficient.

The second control quantity determination unit is configured to input the target CEO frequency control data and the target repetition rate control data to a second decoupling module to output a second control quantity, wherein the second decoupling module performs calculation on the target CEO frequency control data and the target repetition rate control data by using the coupling coefficients in the coupling coefficient set to obtain the second control quantity.

A first digital-to-analog converter converts the first control quantity into a first control signal, and simultaneously, a second digital-to-analog converter converts the second control quantity into a second control signal. The first control signal is amplified via a first amplifier, and the amplified first control signal is inputted to a CEO frequency control module in the optical frequency comb system. The second control signal is amplified via a second amplifier, and the amplified second control signal is inputted to a repetition rate control module in the optical frequency comb system.

In an embodiment, the first generation unit includes a first mixing unit and a first filtering unit.

The first mixing unit is configured to input both the first electrical signal and the CEO frequency RF reference signal to a first digital mixer to output a first mixing result.

The first filtering unit is configured to input the first mixing result to a first digital low-pass filter to output the target CEO frequency error signal.

The second generation unit includes a second mixing unit and a second filtering unit.

The second mixing unit is configured to input both the second electrical signal and the repetition rate RF reference signal to a second digital mixer to output a second mixing result.

The second filtering unit is configured to input the second mixing result to a second digital low-pass filter to output the target repetition rate error signal.

In an embodiment, a unit for generating the coupling coefficient set includes a first measurement unit, a first determination unit, a second measurement unit and a second determination unit.

The first measurement unit is configured to adjust an output of the first digital-to-analog converter after the optical frequency comb system is powered on and operates stably over a target duration, and measure a first variation of a CEO frequency and a first variation of a repetition rate.

The first determination unit is configured to determine the first coupling coefficient based on the first variation of the CEO frequency and further configured to determine the second coupling coefficient based on the first variation of the repetition rate.

The second measurement unit is configured to adjust an output of the second digital-to-analog converter after the optical frequency comb system is powered on and operates stably over the target duration, and measure a second variation of the CEO frequency and a second variation of the repetition rate.

The second determination unit is configured to determine the third coupling coefficient based on the second variation of the CEO frequency and further configured to determine the fourth coupling coefficient based on the second variation of the repetition rate.

In a third aspect, an electronic device is provided according to the present disclosure. The device includes: one or more processors, and a storage apparatus where one or more programs are stored.

The one or more programs, when being executed by the one or more processors, cause the processor to implement the method for optical frequency comb locking described in any one of embodiments of the first aspect.

In a fourth aspect, a computer storage medium having a computer program stored thereon is provided according to the present disclosure. The computer program, when being executed by a processor, implements the method for optical frequency comb locking described in any one of the embodiments of the first aspect.

It can be seen from the foregoing embodiments, a method and an apparatus for optical frequency comb locking are provided according to the present disclosure. The method includes: acquiring a first electrical signal outputted by a CEO frequency detection module and a second electrical signal outputted by a repetition rate detection module in an optical frequency comb system; generating a target CEO frequency control data based on the first electrical signal and a CEO frequency RF reference signal; generating target repetition rate control data based on the second electrical signal and the repetition rate RF reference signal; inputting the target CEO frequency control data and the target repetition rate control data to the first decoupling module and inputting the target CEO frequency control data and the target repetition rate control data to the second decoupling module for performing decoupling synchronously, to obtain the first control quantity and the second control quantity; and synchronously converting the first control quantity into the first control signal by the first digital-to-analog converter and converting the second control quantity into the second control signal by the second digital-to-analog converter. The first control signal is amplified via the first amplifier and inputted to the CEO frequency control module in the optical frequency comb system, and the second control signal is amplified via the second amplifier and inputted to the repetition rate control module in the optical frequency comb system. Thus, the coupling between the two locked loops (CEO frequency and repetition rate) is reduced, the phase noise is reduced, and it is ensured that the two locked loops have the same bandwidth, which is beneficial to the improvement of the locking bandwidth.

### BRIEF DESCRIPTION OF THE DRAWINGS

In order to more clearly describe the embodiments of the present disclosure, the drawings to be used in the description of the embodiments are briefly described below. Apparently, the drawings described in the following description show only some embodiments of the present disclosure.

FIG. 1 is a flowchart of a method for optical frequency comb locking according to an embodiment of the present disclosure;

FIG. 2 is a flowchart of a method for generating a carrier-envelope offset (CEO) frequency error signal according to another embodiment of the present disclosure;

FIG. 3 is a flowchart of a method for generating a repetition rate error signal according to another embodiment of the present disclosure;

FIG. 4 is a system block diagram of a method for optical frequency comb locking according to another embodiment of the present disclosure; and

FIG. 5 is a schematic diagram of an apparatus for optical frequency comb locking according to another embodiment of the present disclosure.

### DETAILED DESCRIPTION

Embodiments of the present disclosure are clearly and completely described hereinafter in conjunction with the drawings of the embodiments of the present disclosure. Apparently, the embodiments described are only some embodiments of the present disclosure, rather than all embodiments. Any other embodiments based on the embodiments in the present disclosure work fall within the protection scope of the present disclosure.

The terms “include” and its variations, as used herein, are open-ended, meaning “including but not limited to.” The term “based on” means “based at least in part on.” The term “an embodiment” refers to “at least one embodiment”. The term “another embodiment” refers to “at least one further embodiment”. The term “some embodiments” refers to “at least some embodiments.” Further definitions of terms, if not provided herein, may be found in the detailed description below.

It should be noted that the information (including but not limited to user equipment information, user personal information, etc.) and data (including but not limited to data used for analysis, stored data, displayed data, etc.) involved in the present disclosure are information and data authorized by users or fully authorized by all parties, and the collection, use and processing of relevant data must comply with applicable laws, regulations and standards of relevant countries and regions.

It should be noted that concepts such as “first” and “second” mentioned in the present disclosure are only used to distinguish different apparatuses, modules, or units, and are not used to limit the order or interdependence of functions performed by the apparatuses, modules, or units.

It should be noted that “a” or “an” and “a plurality of” or “multiple” mentioned in the present disclosure are illustrative and not limiting, and they should be understood in the art as “one or multiple” unless the context explicitly stated otherwise.

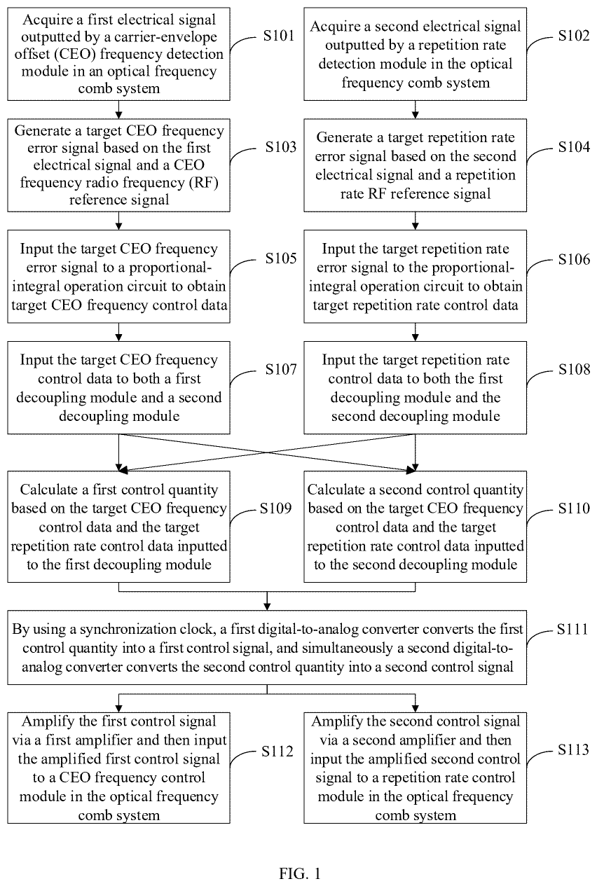

Referring to FIG. 1, a method for optical frequency comb locking according to an embodiment of the present disclosure includes steps S101 to S113.

In step S101, a first electrical signal, outputted by a carrier-envelope offset (CEO) frequency detection module in an optical frequency comb system, is acquired.

In step S102, a second electrical signal, outputted by a repetition rate detection module in the optical frequency comb system, is acquired.

In step S103, a target CEO frequency error signal is generated based on the first electrical signal and a CEO frequency radio frequency (RF) reference signal.

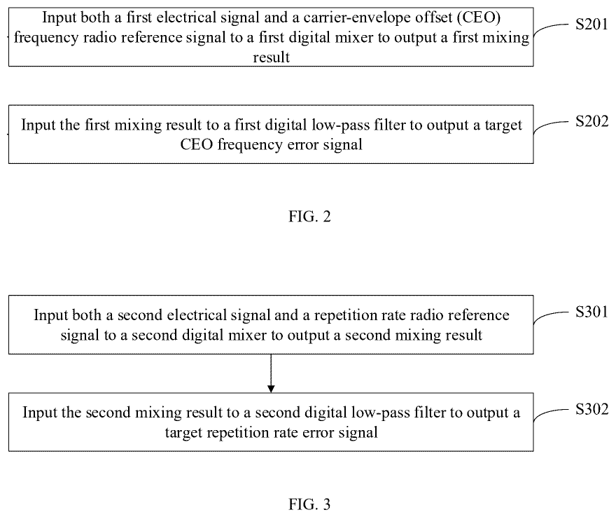

Referring to FIG. 2, in an embodiment of the present disclosure, step S103 includes steps S201 and S202.

In step S201, both the first electrical signal and the CEO frequency RF reference signal are inputted to a first digital mixer, and the first digital mixer outputs a first mixing result.

In step S202, the first mixing result is inputted to a first digital low-pass filter to obtain a target CEO frequency error signal.

In step S104, a target repetition rate error signal is generated based on the second electrical signal and a repetition rate RF reference signal.

Referring to FIG. 3, in an embodiment of the present disclosure, step S104 includes steps S301 and S302.

In step S301, both the second electrical signal and the repetition rate RF reference signal are inputted to a second digital mixer, and the second digital mixer outputs a second mixing result.

In step S302, the second mixing result is inputted to a second digital low-pass filter to obtain the target repetition rate error signal.

In step S105, the target CEO frequency error signal is inputted to a proportional-integral operation circuit to obtain target CEO frequency control data.

In step S106, the target repetition rate error signal is inputted to the proportional-integral operation circuit to obtain target repetition rate control data.

In step S107, the target CEO frequency control data is inputted to both a first decoupling module and a second decoupling module.

In step S108, the target repetition rate control data is inputted to both the first decoupling module and the second decoupling module.

In step S109, a first control quantity is calculated based on the target CEO frequency control data and the target repetition rate control data inputted to the first decoupling module.

In step S110, a second control quantity is calculated based on the target CEO frequency control data and the target repetition rate control data inputted to the second decoupling module.

During implementation of the method according to the present disclosure, the first decoupling module performs calculation on the target CEO frequency control data and the target repetition rate control data by using coupling coefficients in a coupling coefficient set to obtain the first control quantity, and the second decoupling module performs calculation on the target CEO frequency control data and the target repetition rate control data by using the coupling coefficients in the coupling coefficient set to obtain the second control quantity.

The coupling coefficient set includes a first coupling coefficient, a second coupling coefficient, a third coupling coefficient and a fourth coupling coefficient. Data in the coupling coefficient set is pre-measured data.

During implementation of the method according to the present disclosure, data may be decoupled by two decoupling modules. The target CEO frequency control data PI_{f}_{_{ceo}} and the target repetition rate control data PI_{f}_{ᵣ} are inputted to both the first decoupling module and the second decoupling module. The coupling coefficient set is pre-stored in the first decoupling module and the second decoupling module.

The first decoupling module determines the first control quantity based on the target CEO frequency control data PI_{f}_{_{ceo}}, the target repetition rate control data PI_{f}_{ᵣ} and the coupling coefficient set. The second decoupling module determines the second control quantity based on the target CEO frequency control data PI_{f}_{_{ceo}}, the target repetition rate control data PI_{f}_{ᵣ} and the coupling coefficient set.

In another embodiment of the present disclosure, an implementation of generating the coupling coefficient set includes: adjusting an output of the first digital-to-analog converter after the optical frequency comb system is powered on and operates stably over a target duration, and measuring a first variation of a CEO frequency and a first variation of 6a repetition rate; determining the first coupling coefficient based on the first variation of the CEO frequency; determining the second coupling coefficient based on the first variation of the repetition rate; adjusting an output of the second digital-to-analog converter after the optical frequency comb system is powered on and operates stably over the target duration, and measuring a second variation of the CEO frequency and a second variation of the repetition rate; determining the third coupling coefficient based on the second variation of the CEO frequency; and determining the fourth coupling coefficient based on the second variation of the repetition rate.

In an embodiment, after the optical frequency comb system is powered on and operates stably over a long time period, typically more than 2 hours, and under a condition that temperature and humidity of a working environment are stable, an output of a first digital-to-analog converter DA1 is adjusted, variations of the CEO frequency f_{ceo} and the repetition rate fᵣ are measured, and a variation m (first variation) of f_{ceo} and a variation n (second change) of fᵣ corresponding to DA1 output value varying by 1 are calculated, where m and n are in Hz; an output of a second digital-analog converter DA2 is adjusted, variations of f_{ceo} and fᵣ are measured, and a variation j (third variation) of f_{ceo} and a variation k (fourth variation) of fᵣ corresponding to DA2 output value varying by 1 are calculated, where j and k are in Hz. The values m, n, j and k obtained during the process are the coupling coefficients of the optical frequency comb system.

Based on the target CEO frequency control data, the target repetition rate control data and the coupling coefficient set, the first control quantity S_{f}_{_{ceo}} is calculated by

$${S}_{{f}_{c e o}} = \frac{{kPI}_{{f}_{c e o}} - {jPI}_{{f}_{r}}}{m k - n j}$$

where S_{f}_{_{ceo}} represents the first control quantity, PI_{f}_{_{ceo}} represents the target CEO frequency control data and PI_{f}_{ᵣ} represents the target repetition rate control data.

Based on the target CEO frequency control data, the target repetition rate control data and the coupling coefficient set, a second control quantity S_{f}_{ᵣ} is calculated by

$${S}_{{f}_{r}} = \frac{{nPI}_{{f}_{c e o}} - {mPI}_{{f}_{r}}}{j n - k m}$$

where S_{f}_{ᵣ} represents the second control quantity, PI_{f}_{_{ceo}} represents the target CEO frequency control data and PI_{f}_{ᵣ} represents the target repetition rate control data. Values of S_{f}_{_{ceo}} and S_{f}_{ᵣ} are obtained through simultaneous solving of the two equations.

During implementation of the method according to the present disclosure, the working environmental conditions with stable temperature and humidity may be implemented by, but not limited to, variations less than 5% over a 12-hour period, which is not limited herein. The repetition rate of the optical frequency comb is 100 MHz, a Z-cut electro-optic crystal is configured for control over f_{ceo}, a Y-cut electro-optic crystal is configured for control over fᵣ, and DA1 and DA2 use 16-bit parallel DAC chips. The digital mixers, the low-pass filters, the proportional-integral modules, the decoupling modules, etc. are all implemented in a field-programmable gate array (FPGA). After the optical frequency comb system is powered on and operates stably for 2 hours, the output of DA1 is increased by 0.1V, and then the voltage variation is increased to 1V by means of amplification. The variations of f_{ceo} and fᵣ are measured, the variation m of f_{ceo} and variation n of fᵣ corresponding to a variation of 1 mV in the DA1 output value. It is calculated that m=76.3 Hz/mV and n=5.3 Hz/mV. The output of DA2 is increased by 0.1V, and then the voltage variation is increased to 1V by means of amplification. The variations of f_{ceo} and fᵣ are measured, the variation j of f_{ceo} and variation k of fᵣ corresponding to a variation of 1 mV in the DA2 output value. It is calculated that j=12.2 Hz/mV and k=152.6 Hz/mV. The values m, n, j and k obtained during the process are the coupling coefficients of the optical frequency comb system.

In view of the above, based on the target CEO frequency control data, the target repetition rate control data and the coupling coefficient set, the first control quantity S_{f}_{_{ceo}} is calculated by

$${S}_{{f}_{c e o}} = \frac{152 \text{.6} {PI}_{{f}_{c e o}} - 12 \text{.2} {PI}_{{f}_{r}}}{76.3 \times 152.6 - 5.3 \times 12.2}$$

where S_{f}_{_{ceo}} represents the first control quantity, PI_{f}_{_{ceo}} represents the target CEO frequency control data and PI_{f}_{ᵣ} represents the target repetition rate control data.

Based on the target CEO frequency control data, the target repetition rate control data and the coupling coefficient set, the second control quantity S_{f}_{ᵣ} is calculated by

$${S}_{{f}_{r}} = \frac{5 \text{.3} {PI}_{{f}_{c e o}} - 76 \text{.3} {PI}_{{f}_{r}}}{12.2 \times 5.3 - 152.6 \times 76.3}$$

In step S111, with a synchronous clock, the first digital-to-analog converter converts the first control quantity into the first control signal, and simultaneously the second digital-to-analog converter converts the second control quantity into the second control signal.

In step S112, the first control signal is amplified via a first amplifier and is inputted to a CEO frequency control module in the optical frequency comb system.

In step S113, the second control signal is amplified via a second amplifier and is inputted into a repetition rate control module in the optical frequency comb system.

During implementation of the method according to the present disclosure, steps S101 to S113 are repeated to achieve continuous synchronous closed-loop operation of the two locked loops f_{ceo} and fᵣ.

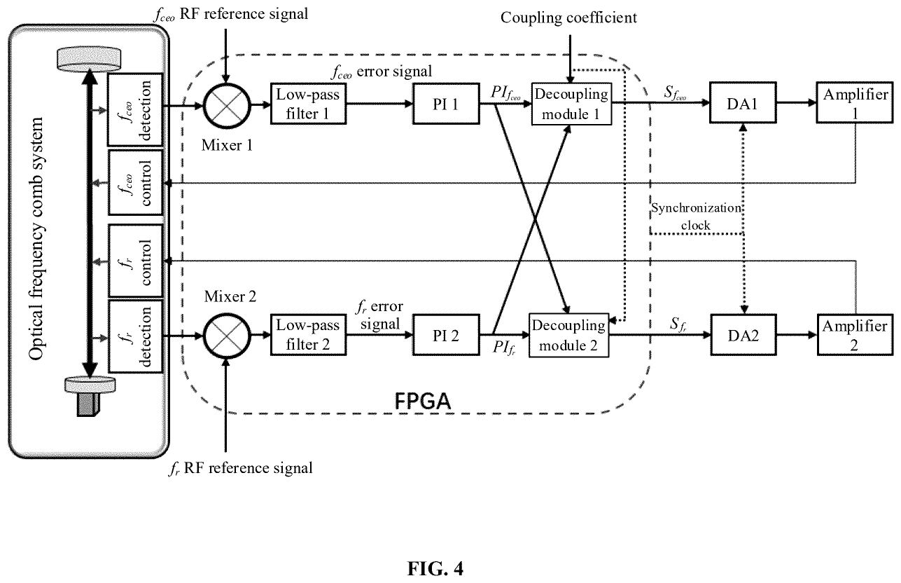

Referring to FIG. 4, FIG. 4 is a system block diagram of a method for optical frequency comb locking according to an embodiment of the present disclosure. In the optical frequency comb system, the CEO frequency detection module (shown as f_{ceo} detection in FIG. 4) outputs the first electrical signal, and the repetition rate detection module (shown as fᵣ detection in FIG. 4) outputs the second electrical signal. The first electrical signal and the CEO frequency RF reference signal (shown as f_{ceo} RF reference signal in FIG. 4) are both inputted to the first digital mixer (shown as mixer 1 in FIG. 4), and the first mixing result is outputted. The first mixing result is inputted to the first digital low-pass filter (shown as low-pass filter 1 in FIG. 4), and the CEO frequency error signal (shown as f_{ceo} error signal in FIG. 4) is outputted. The proportional-integral (shown as PI 1 in FIG. 4) operation is performed on the CEO frequency error signal, and the target CEO frequency control data PI_{f}_{_{ceo}} is obtained. The second electrical signal and the repetition rate RF reference signal (shown as fᵣ RF reference signal in FIG. 4) are both inputted to the second digital mixer (shown as mixer 2 in FIG. 4), and the second mixing result is outputted. The second mixing result is inputted to the second digital low-pass filter (shown as low-pass filter 2 in FIG. 4), and the repetition rate error signal (shown as fᵣ error signal in FIG. 4) is outputted. The proportional-integral (shown as PI 2 in FIG. 4) operation is performed on the repetition rate error signal, and the target repetition rate control data PI_{f}_{ᵣ} is obtained.

PI_{f}_{ᵣ} is inputted to the first decoupling module (shown as decoupling module 1 in FIG. 4) and the second decoupling module (shown as decoupling module 2 in FIG. 4), and PI_{f}_{_{ceo}} is inputted to the first decoupling module (shown as decoupling module 1 in FIG. 4) and the second decoupling module (shown as decoupling module 2 in FIG. 4). The first decoupling module determines the first control quantity based on the target CEO frequency control data, the target repetition rate control data, and the coupling coefficient set. The second decoupling module determines the second control quantity S_{f}_{ᵣ} based on the target CEO frequency control data, the target repetition rate control data and the coupling coefficient set. With a synchronous clock, the first digital-to-analog converter (DA1 in FIG. 4) converts the first control quantity S_{f}_{_{ceo}} into the first control signal, while the second digital-to-analog converter (DA2 in FIG. 4) converts the second control quantity S_{f}_{ᵣ} into the second control signal synchronously. The first control signal is amplified via the first amplifier (amplifier 1 in FIG. 4), and then inputted to the CEO frequency control module (f_{ceo} control in FIG. 4) in the optical frequency comb system. The second control signal is amplified via the second amplifier (amplifier 2 in FIG. 4), and then inputted to the repetition rate control module (fᵣ control in FIG. 4) in the optical frequency comb system.

It should be noted that, with a conventional method, an influence coefficient n/m of the f_{ceo} locked loop on the fᵣ locked loop is approximately 6.9% and an influence coefficient j/k of the fᵣ locked loop on the f_{ceo} locked loop is approximately 8.0%. As tested, with the method for optical frequency comb locking according to the present disclosure, both the influence coefficients are reduced to less than 0.5%, which is a significant reduction. With the conventional method, the maximum control bandwidth of the locked loop is approximately 100 kHz and a bandwidth of fᵣ is approximately 500 kHz, that is, system stability is ensured by reducing a locking bandwidth of f_{ceo}. As tested, with the method according to the present disclosure, the locking bandwidths of f_{ceo} and fᵣ both reach 500 kHz. With the conventional method, a spectrum after fᵣ is locked exhibits residual control coupling noise (around a 100 kHz frequency offset) of f_{ceo}. With the method according to the present disclosure, no noise coupled from one locked loop is detected on the other spectrum after f_{ceo} and fᵣ are locked. Furthermore, the method according to the present disclosure has a wide range of applications and is applicable to any optical frequency comb system, whether it is a system with real-time calculation or a fixed value.

It can be seen from foregoing embodiments, a method for optical frequency comb locking is provided according to the present disclosure. The method includes: acquiring a first electrical signal outputted by a CEO frequency detection module and a second electrical signal outputted by a repetition rate detection module in an optical frequency comb system; generating a target CEO frequency control data based on the first electrical signal and a CEO frequency RF reference signal; generating target repetition rate control data based on the second electrical signal and the repetition rate RF reference signal; inputting the target CEO frequency control data and the target repetition rate control data to the first decoupling module and inputting the target CEO frequency control data and the target repetition rate control data to the second decoupling module for performing decoupling synchronously, to obtain the first control quantity and the second control quantity; and synchronously converting the first control quantity into the first control signal by the first digital-to-analog converter and converting the second control quantity into the second control signal by the second digital-to-analog converter. The first control signal is amplified via the first amplifier and inputted to the CEO frequency control module in the optical frequency comb system, and the second control signal is amplified via the second amplifier and inputted to the repetition rate control module in the optical frequency comb system. Thus, the coupling between the two locked loops (CEO frequency and repetition rate) is reduced, the phase noise is reduced, and it is ensured that the two locked loops have the same bandwidth, which is beneficial to the improvement of the locking bandwidth.

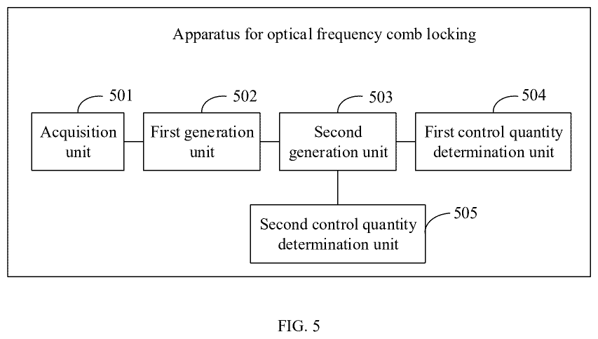

Referring to FIG. 5, an apparatus for optical frequency comb locking according to an embodiment of the present disclosure includes an acquisition unit 501, a first generation unit 502, a second generation unit 503, a first control quantity determination unit 504, and a second control quantity determination unit 505.

The acquisition unit 501 is configured to acquire a first electrical signal outputted by a CEO frequency detection module and a second electrical signal outputted by a repetition rate detection module in the optical frequency comb system.

The first generation unit 502 is configured to generate a target CEO frequency error signal based on the first electrical signal and a CEO frequency RF reference signal. The proportional-integral operation is performed on the target CEO frequency error signal to obtain target CEO frequency control data.

In another embodiment of the present disclosure, the first generation unit 502 includes a first mixing unit and a first filtering unit.

The first mixing unit is configured to input both the first electrical signal and the CEO frequency RF reference signal to a first digital mixer to output a first mixing result.

The first filtering unit is configured to input the first mixing result to the first digital low-pass filter to output the target CEO frequency error signal.

Working processes of the units in the above-described embodiment of the present disclosure may be referred to in the corresponding method embodiments, as shown in FIG. 2, and are not repeated herein.

The second generation unit 503 is configured to generate the target repetition rate error signal based on the second electrical signal and the repetition rate RF reference signal. The proportional-integral operation is performed on the target repetition rate error signal to obtain target repetition rate control data.

In another embodiment of the present disclosure, the second generation unit 503 includes a second mixing unit and a second filtering unit.

The second mixing unit is configured to input both the second electrical signal and the repetition rate RF reference signal to the second digital mixer to output the second mixing result.

The second filtering unit is configured to input the second mixing result to the second digital low-pass filter to output the target repetition rate error signal.

Working processes of the units in the above-described embodiment of the present disclosure may be referred to in the corresponding method embodiments, as shown in FIG. 3, and are not repeated herein.

The first control quantity determination unit 504 is configured to input the target CEO frequency control data and the target repetition rate control data to the first decoupling module to output the first control quantity.

The first decoupling module performs calculation on the target CEO frequency control data and the target repetition rate control data by using coupling coefficients in a coupling coefficient set to obtain the first control quantity.

The coupling coefficient set includes a first coupling coefficient, a second coupling coefficient, a third coupling coefficient and a fourth coupling coefficient.

The second control quantity determination unit 505 is configured to input the target CEO frequency control data and the target repetition rate control data to the second decoupling module to output the second control quantity.

The second decoupling module performs calculation on the target CEO frequency control data and the target repetition rate control data by using the coupling coefficients in the coupling coefficient set to obtain the second control quantity. The first digital-to-analog converter converts the first control quantity to the first control signal, and simultaneously the second digital-to-analog converter converts the second control quantity to the second control signal synchronously.

The first control signal is amplified via the first amplifier and then inputted to the CEO frequency control module in the optical frequency comb system. The second control signal is amplified via the second amplifier and then inputted to the repetition rate control module in the optical frequency comb system.

Working processes of the units in the above-described embodiment of the present disclosure may be referred to in the corresponding method embodiment, as shown in FIG. 1, and are not repeated herein.

In another embodiment of the present disclosure, the unit for generating the coupling coefficient set includes a first measurement unit, a first determination unit, a second measurement unit and a second determination unit.

The first measurement unit is configured to adjust an output of the first digital-to-analog converter after the optical frequency comb system is powered on and operates stably over a target duration, and measure a first variation of a CEO frequency and a first variation of a repetition rate.

The first determination unit is configured to determine the first coupling coefficient based on the first variation of the CEO frequency, and further configured to determine the second coupling coefficient based on the first variation of the repetition rate.

The second measurement unit is configured to adjust an output of the second digital-to-analog converter after the optical frequency comb system is powered on and operates stably over a target duration, and measure a second variation of the CEO frequency and a second variation of the repetition rate.

The second determination unit is configured to determine the third coupling coefficient based on the second variation of the CEO frequency, and further configured to determine the fourth coupling coefficient based on the second variation of the repetition rate.

Working processes of the units in the above-described embodiment of the present disclosure may be referred to in the corresponding method embodiment and are not repeated herein.

It can be seen from the foregoing embodiments, an apparatus for optical frequency comb locking is provided according to the present disclosure. The acquisition unit 501 acquires a first electrical signal outputted by a CEO frequency detection module and a second electrical signal outputted by a repetition rate detection module in an optical frequency comb system. The first generation unit 502 generates target CEO frequency control data based on the first electrical signal and a CEO frequency RF reference signal. The second generation unit 503 generates target repetition rate control data based on the second electrical signal and the repetition rate RF reference signal. The first control quantity determination unit 504 inputs the target CEO frequency control data and the target repetition rate control data to the first decoupling module and the second control quantity determination unit 505 inputs the target CEO frequency control data and the target repetition rate control data to the second decoupling module for performing decoupling synchronously. The first control quantity and the second control quantity are obtained. The first digital-to-analog converter converts the first control quantity into the first control signal, and simultaneously the second digital-to-analog converter converts the second control quantity into the second control signal. The first control signal is amplified via the first amplifier and inputted to the CEO frequency control module in the optical frequency comb system, and the second control signal is amplified via the second amplifier and inputted to the repetition rate control module in the optical frequency comb system. Thus, the coupling between the two locked loops (CEO frequency and repetition rate) is reduced, the phase noise is reduced, and it is ensured that the two locked loops have the same bandwidth, which is beneficial to the improvement of the locking bandwidth.

The functions described above herein may be performed, at least in part, by one or multiple hardware logic components. For example, and without limitation, exemplary types of hardware logic components that may be used include: a field-programmable gate array (FPGA), an application-specific integrated circuit (ASIC), an application-specific standard product (ASSP), a system on a chip (SOC), a complex programmable logic device (CPLD), and the like.

In another embodiment of the present disclosure, an electronic device is provided. The electronic device includes one or more processors, and a storage apparatus.

The storage apparatus stores one or more programs.

The one or more programs, when being executed by the one or more processors, cause the processor to implement the method for optical frequency comb locking described in any one of the above embodiments.

In another embodiment of the present disclosure, a computer storage medium having a computer program stored thereon is provided. The computer program, when being executed by a processor, implements the method for optical frequency comb locking described in any one of the above embodiments.

Although the subject matter is described in language specific to structural features and/or methodological logical acts, it should be understood that the subject matter defined in present disclosure is not necessarily limited to the specific features or acts described above. Rather, the specific features and acts described above are merely exemplary forms of implementing the present disclosure.

Implementation details included in the above description should not be construed as limitation on the scope of the present disclosure. Certain features described in the context of individual embodiments may also be implemented in combination in a single embodiment. Various features described in the context of a single embodiment may also be implemented separately or in any suitable sub-combination across multiple embodiments.

The above description is merely an explanation of embodiments and principles employed in the present disclosure. The scope referred to in the present disclosure is not limited to the embodiments formed by a specific combination of the above-embodiments, but also includes other embodiments formed by any combination of the above-described features or their equivalent features without departing from the concept of the above-described disclosure. The embodiments may be formed by replacing the above-described features with features having similar functions applied in the present disclosure (but not limited to).

1. A method for optical frequency comb locking, comprising:
acquiring a first electrical signal outputted by a carrier-envelope offset (CEO) frequency detection module and a second electrical signal outputted by a repetition rate detection module in an optical frequency comb system;
generating a target CEO frequency error signal based on the first electrical signal and a CEO frequency radio frequency (RF) reference signal, and calculating target CEO frequency control data through performing a proportional-integral operation on the target CEO frequency error signal;
generating a target repetition rate error signal based on the second electrical signal and a repetition rate RF reference signal, and calculating target repetition rate control data through performing the proportional-integral operation on the target repetition rate error signal;
inputting the target CEO frequency control data and the target repetition rate control data to a first decoupling module to output a first control quantity, wherein the first decoupling module performs calculation on the target CEO frequency control data and the target repetition rate control data by using coupling coefficients in a coupling coefficient set to obtain the first control quantity, wherein the coupling coefficient set comprises a first coupling coefficient, a second coupling coefficient, a third coupling coefficient and a fourth coupling coefficient;
inputting the target CEO frequency control data and the target repetition rate control data to a second decoupling module to output a second control quantity, wherein the second decoupling module performs calculation on the target CEO frequency control data and the target repetition rate control data by using the coupling coefficients in the coupling coefficient set to obtain the second control quantity;
converting the first control quantity into a first control signal by a first digital-to-analog converter and simultaneously, converting the second control quantity into a second control signal by a second digital-to-analog converter;
amplifying the first control signal via a first amplifier, and inputting the amplified first control signal to a CEO frequency control module in the optical frequency comb system; and
amplifying the second control signal via a second amplifier, and inputting the amplified second control signal to a repetition rate control module in the optical frequency comb system.

2. The method for optical frequency comb locking according to claim 1, wherein the generating a target CEO frequency error signal based on the first electrical signal and a CEO frequency radio frequency (RF) reference signal comprises:
inputting the first electrical signal and the CEO frequency RF reference signal to a first digital mixer to output a first mixing result; and
inputting the first mixing result to a first digital low-pass filter to obtain the target CEO frequency error signal.

3. The method for optical frequency comb locking according to claim 1, wherein the generating a target repetition rate error signal based on the second electrical signal and a repetition rate RF reference signal comprises:
inputting the second electrical signal and the repetition rate RF reference signal to a second digital mixer to output a second mixing result; and
inputting the second mixing result to a second digital low-pass filter to obtain the target repetition rate error signal.

4. The method for optical frequency comb locking according to claim 1, wherein generating the coupling coefficient set comprises:
adjusting an output of the first digital-to-analog converter after the optical frequency comb system is powered on and operates stably over a target duration, and measuring a first variation of a CEO frequency and a first variation of a repetition rate;
determining the first coupling coefficient based on the first variation of the CEO frequency;
determining the second coupling coefficient based on the first variation of the repetition rate;
adjusting an output of the second digital-to-analog converter after the optical frequency comb system is powered on and operates stably over the target duration, and measuring a second variation of the CEO frequency and a second variation of the repetition rate;
determining the third coupling coefficient based on the second variation of the CEO frequency; and
determining the fourth coupling coefficient based on the second variation of the repetition rate.

5. An apparatus for optical frequency comb locking, comprising:
an acquisition unit, configured to acquire a first electrical signal outputted by a carrier-envelope offset (CEO) frequency detection module and a second electrical signal outputted by a repetition rate detection module in an optical frequency comb system;
a first generation unit, configured to generate a target CEO frequency error signal based on the first electrical signal and a CEO frequency radio frequency (RF) reference signal, wherein a proportional-integral operation is performed on the target CEO frequency error signal to obtain target CEO frequency control data;
a second generation unit, configured to generate a target repetition rate error signal based on the second electrical signal and a repetition rate RF reference signal, wherein the proportional-integral operation is performed on the target repetition rate error signal to obtain target repetition rate control data;
a first control quantity determination unit, configured to input the target CEO frequency control data and the target repetition rate control data to a first decoupling module to output a first control quantity, wherein the first decoupling module performs calculation on the target CEO frequency control data and the target repetition rate control data by using coupling coefficients in a coupling coefficient set to obtain the first control quantity, wherein the coupling coefficient set comprises a first coupling coefficient, a second coupling coefficient, a third coupling coefficient and a fourth coupling coefficient; and
a second control quantity determination unit, configured to input the target CEO frequency control data and the target repetition rate control data to a second decoupling module to output a second control quantity, wherein the second decoupling module performs calculation on the target CEO frequency control data and the target repetition rate control data by using the coupling coefficients in the coupling coefficient set to obtain the second control quantity, and wherein
a first digital-to-analog converter converts the first control quantity into a first control signal, and simultaneously, a second digital-to-analog converter converts the second control quantity into a second control signal; the first control signal is amplified via a first amplifier, and the amplified first control signal is inputted to a CEO frequency control module in the optical frequency comb system; and the second control signal is amplified via a second amplifier, and the amplified second control signal is inputted to a repetition rate control module in the optical frequency comb system.

6. The apparatus for optical frequency comb locking according to claim 5, wherein the first generation unit comprises:
a first mixing unit, configured to input both the first electrical signal and the CEO frequency RF reference signal to a first digital mixer to output a first mixing result; and
a first filtering unit, configured to input the first mixing result to a first digital low-pass filter to output the target CEO frequency error signal.

7. The apparatus for optical frequency comb locking according to claim 5, wherein the second generation unit comprises:
a second mixing unit, configured to input both the second electrical signal and the repetition rate RF reference signal to a second digital mixer to output a second mixing result; and
a second filtering unit, configured to input the second mixing result to a second digital low-pass filter to output the target repetition rate error signal.

8. The apparatus for optical frequency comb locking according to claim 5, wherein a unit for generating the coupling coefficient set comprises:
a first measurement unit, configured to adjust an output of the first digital-to-analog converter after the optical frequency comb system is powered on and operates stably over a target duration, and measure a first variation of a CEO frequency and a first variation of a repetition rate;
a first determination unit, configured to determine the first coupling coefficient based on the first variation of the CEO frequency and further configured to determine the second coupling coefficient based on the first variation of the repetition rate;
a second measurement unit, configured to adjust an output of the second digital-to-analog converter after the optical frequency comb system is powered on and operates stably over the target duration, and measure a second variation of the CEO frequency and a second variation of the repetition rate; and
a second determination unit, configured to determine the third coupling coefficient based on the second variation of the CEO frequency and further configured to determine the fourth coupling coefficient based on the second variation of the repetition rate.
